(19) United States
(12) Patent Application Publication
(10) Pub. No.: US 2017/0358389 A1
(43) Pub. Date: Dec. 14, 2017

(54) TRANSFORMER ENCLOSURE WITH IMPROVED COOLING

(71) Applicant: ABB Technology AG, Zurich (CH)

(72) Inventors: Brian J. Akers, Ivanhoe, VA (US); Wei Wu, Wytheville, VA (US); Craig D. Helewski, Wytheville, VA (US); Joel A. Kern, Wytheville, VA (US)

(21) Appl. No.: 15/176,504

(22) Filed: Jun. 8, 2016

(51) Int. Cl. H01F 27/02; H01F 27/28; H01F 27/24

(52) U.S. Cl. CPC H01F 27/025; H01F 27/24; H01F 27/28

(57) ABSTRACT

A transformer is provided that includes an enclosure configured to house a core and a coil assembly mounted to the core. The enclosure includes a number of vertically extending sidewalls, at least one top wall connecting the sidewalls, and a bottom end opposite the at least one top wall. At least one of the sidewalls is joined to an access panel that is angled below the at least one top wall and extends between the bottom end of the enclosure and the vertically extending at least one sidewall. A first ventilation opening is provided in the angled access panel and a second ventilation opening is provided in the at least one sidewall adjacent to and/or in the top wall.

### FIELD OF THE INVENTION

This invention relates to transformers and more particularly to a transformer enclosure with improved cooling.

### BACKGROUND

An electrical transformer converts electricity at one voltage to electricity at another voltage, either of higher or lower value. This voltage conversion is achieved using a coil assembly that includes a primary coil and a secondary coil in the transformer, each of which are wound on a ferromagnetic core and comprise a number of turns of an electrical conductor. The primary coil is connected to a source of voltage and the secondary coil is connected to a load. The coil assembly is mounted to a leg of the core, and the core includes first and second yokes connected by the leg. Certain transformers include multiple legs and a coil assembly on each leg.

For dry type transformers, such as those with coils for open windings, the core and coil assemblies are placed in an enclosure. In dry transformers, the high voltage conductor of the coil assembly is not embedded in resin. The resistance to the electric current by the metal wires of the transformer produces heat in the enclosure. The production of heat further increases the resistance to the current, and the overall efficiency of the transformer is reduced by the added heat unless the heat is removed from the enclosure.

Thus, some transformer enclosures include ventilation openings for circulation of air currents through the enclosure. However, restrictions and/or resistance to air flow through transformer enclosures can result in thermal build-up in the enclosure and increased inefficiencies in the transformer cooling process. Therefore, further improvements in transformer enclosures to provide improved cooling are needed.

### SUMMARY

In accordance with the present disclosure, a transformer is provided that includes an enclosure configured to house a core along with a coil assembly mounted to the core. The enclosure includes a number of vertically extending sidewalls, at least one top wall connecting the sidewalls at or adjacent to a top end of the enclosure, and a bottom end opposite the top end. At least one of the sidewalls is joined to an access panel that is angled to extend below the top wall and between the bottom end of the enclosure and the at least one sidewall. A first ventilation opening is provided in the access panel and a second ventilation opening is provided in the at least one sidewall adjacent the top wall.

Since the first ventilation opening is provided in the angled access panel, air flow through the first ventilation opening and into the enclosure is improved due to less air flow resistance. The disclosed embodiments improve cooling and ventilation of transformers enclosures as compared to standard enclosures. The reduced heat build-up within the enclosure may reduce the size and material cost of the enclosed transformer.

This summary is provided to introduce a selection of concepts that are further described below in the illustrative embodiments. This summary is not intended to identify key or essential features of the claimed subject matter, nor is it intended to be used as an aid in limiting the scope of the claimed subject matter. Further embodiments, forms, objects, features, advantages, aspects, and benefits shall become apparent from the following description and drawings.

### BRIEF DESCRIPTION OF THE DRAWINGS

FIG. 1 is a schematic perspective view of one embodiment of a transformer enclosure.

FIG. 2 is a schematic elevational view of the transformer enclosure looking toward the left hand side of the perspective view of FIG. 1.

FIG. 3 is another schematic elevational view of the transformer enclosure looking toward a right hand side that is opposite the left hand side of the perspective view of FIG. 1.

FIG. 4 is a schematic elevational view of a side connecting the left hand and right hand sides of FIGS. 2 and 3 with the wall panel(s) omitted to show structural supports.

### DETAILED DESCRIPTION OF THE ILLUSTRATED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

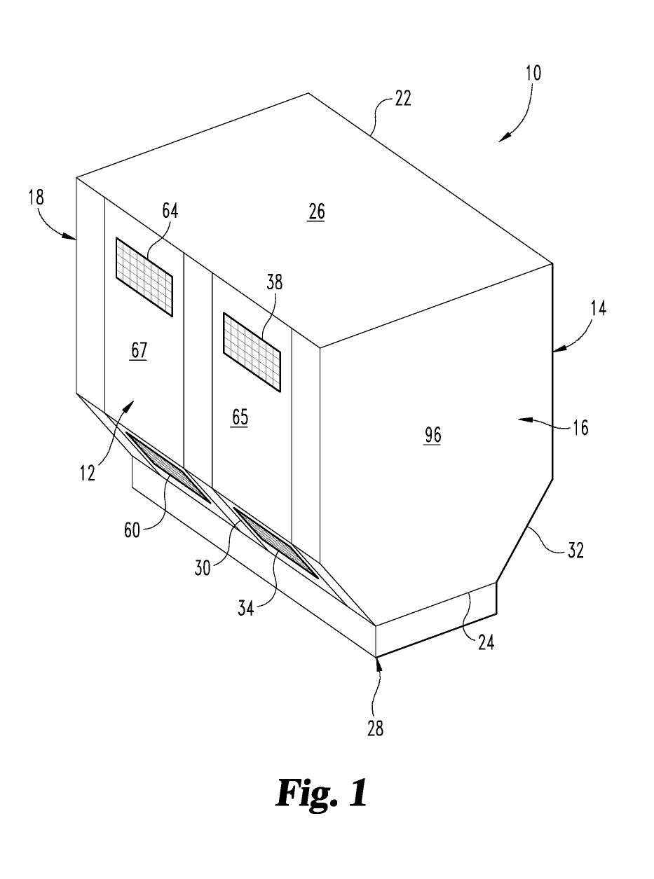

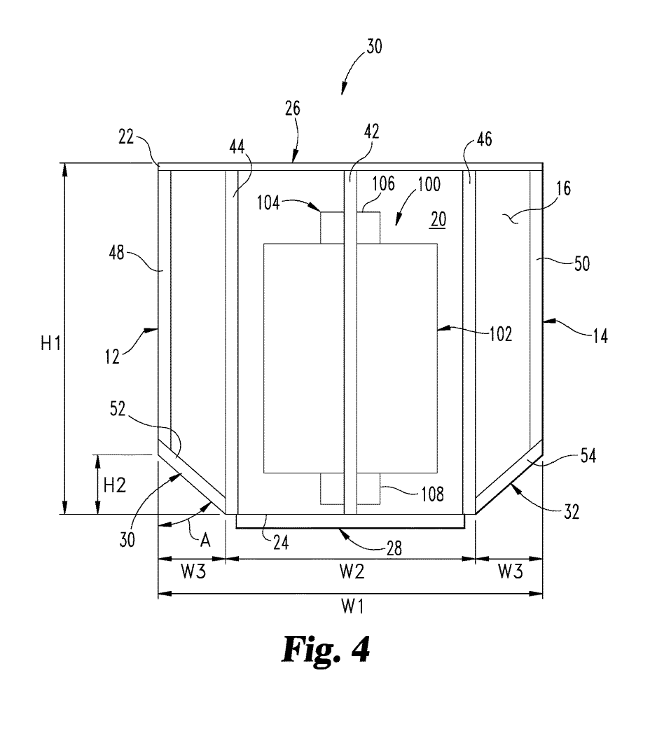

Referring now to FIG. 1, there is shown a diagrammatic perspective view of a ventilated transformer enclosure 10 that can house, for example, a three phase, open wound dry transformer 100, shown schematically in FIG. 4. In one embodiment, the transformer 100 comprises three coil assemblies 102 (one for each phase, only one shown in the end view of FIG. 4) mounted to the core 104 and enclosed within enclosure 10. The core 104 can be made of ferromagnetic metal, and is generally rectangular in shape with three spaced-apart legs (not shown) extending between first and second yokes 106, 108. The coil assemblies 102 are mounted to and disposed around respective legs of the core 104.

In one embodiment, the transformer 100 is a distribution transformer and has a kVA rating in a range of from about 112.5 kVA to about 15,000 kVA. The voltage of the high voltage coil is in a range of from about 600 V to about 35 kV and the voltage of the low voltage coil is in a range of from about 120 V to about 15 kV. However, other types of transformers, ratings and voltages are also contemplated and not precluded. Although the transformer 100 is shown and described as being a three phase transformer, it should be appreciated that the present invention is not limited to three phase transformers. For example, the present invention may be utilized in single phase and two phase transformers as well.

Enclosure 10 includes a plurality of vertically extending sidewalls, designated as first sidewall 12, second sidewall 14, third sidewall 16, and fourth sidewall 18, that collectively form an inner space 20 that houses transformer 100 as shown in FIG. 4. Vertically extending sidewalls 12, 14, 16, 18 extend in a vertical or near vertical orientation. The enclosure 10 extends between a top end 22 and an opposite bottom end 24. At top end 22, at least one top wall 26 extends over the inner space 22 and connects the plurality of vertically extending sidewalls 12, 14, 16, 18 at or adjacent the top end 22 of the enclosure 10. In the illustrated embodiment, top wall 26 is shown as a single section, horizontally-oriented wall panel. Other embodiments contemplate that top wall 26 includes multiple sections, panels, and/or non-horizontal arrangements. In addition, while four vertically extending sidewalls 12, 14, 16, 18 are shown that each extend transversely to one another to define a square or rectangular horizontal shape in a plan view, more than four sidewalls can be provided to form rectangular or non-rectangular shapes.

Transformer enclosure 10 further includes a base 28 at the bottom end 24 of the enclosure 10. Base 28 can be a skid, platform, rails or other suitable structure to support enclosure 10 and transformer 100, such as on the ground, a concrete pad, a foundation, or on any other suitable structure or surface. Sidewalls 12, 14, 16, 18 are connected to base 28 by one or more columns or struts, as discussed further below. In addition, transformer 100 can be supported on base 28.

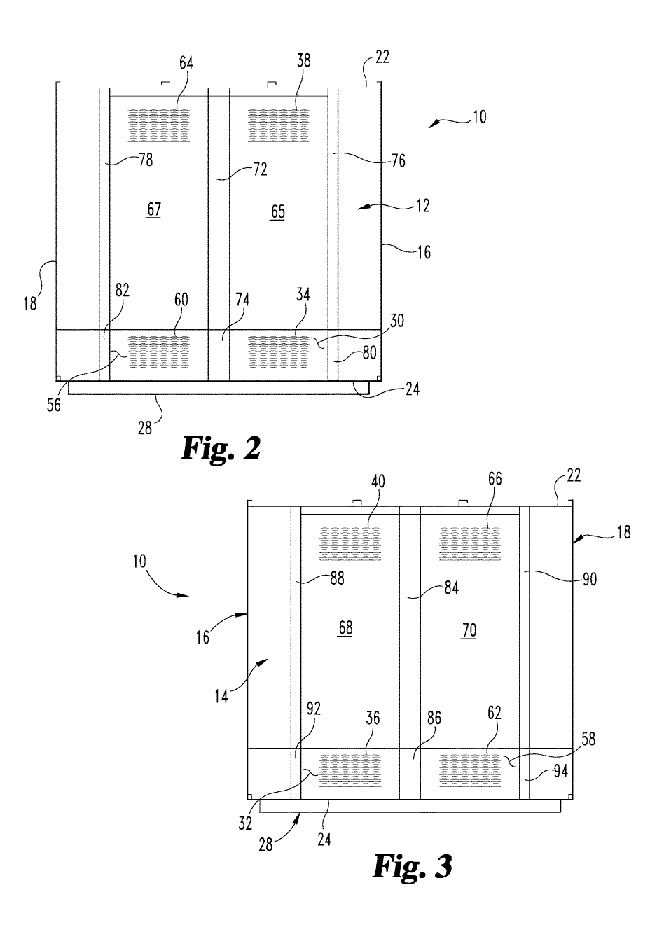

Referring further to FIGS. 2-4, enclosure 10 further includes at least one first access panel 30 associated with first sidewall 12 and at least one second access panel 32 associated with a second sidewall 14 opposite first sidewall 12. Each access panel 30, 32 extends in an angular orientation from and relative to the respective first or second sidewall 12, 14 toward base 28 so that each access panel 32 is directly vertically below the at least one top wall 26. Each of the access panels 30, 32 includes at least one ventilation opening 34, 36, respectively, to allow air inflow into enclosure 10. In addition, each of the associated vertically extending first and second sidewalls 12, 14 includes at least one ventilation opening 38, 40 above the respective access panel ventilation openings 34, 36 to allow air outflow. Other embodiments contemplate multiple ventilation openings in the first and second sidewalls 12, 14 and/or in the respective access panels 30, 32.

Opposite third and fourth vertically extending sidewalls 16, 18 each extend from base 28 to top wall 26 in a vertical or near-vertical orientation. Third and fourth sidewalls 16, 18 also extend between and connect each of the first and second sidewalls 12, 14 and the first and second access panels 30, 32. The third and fourth sidewalls 16, 18 are identical and therefore will be described together with reference to third sidewall 16 in FIG. 4, it being understood the description of third sidewall 16 is applicable to fourth sidewall 18. Furthermore, in FIG. 4 the wall panels on third sidewall 16 are removed to better show the interior coil assembly 102, the columns, and the struts. In FIG. 1, at least one wall panel 96 is shown that covers the respective third sidewall 16, it being understood that fourth sidewall 18 can similarly include a wall panel. Wall panel 96 extends from top wall 26 to bottom end 24, and from first sidewall 12 and first access panel 30 to second sidewall 14 and second access panel 32. Other embodiments contemplated multiple wall panels one or both of sidewalls 16, 18.

As shown in FIG. 4, third sidewall 16 includes, in the illustrated embodiment, a center column 42, and first and second intermediate columns 44, 46 on opposite sides of center column 42. The illustrated embodiment further includes first and second corner columns 48, 50 that are connected to base 28 with first and second angular corner struts 52, 54. The corner struts 52, 54 extend along the respective access panels 30, 32. Corner struts 52, 54 support corner columns 48, 50 on base 28. Center column 42 and first and second intermediate columns 52, 54 are also supported directly one base 28.

Referring back to FIGS. 2-3, there is shown in the illustrated embodiment a second access panel 56 extending from first sidewall 12 to base 28 that is angled to be directly vertically below the top wall 26 like first access panel 30. The opposite sidewall 12 can also include a similar second access panel 58 as shown in FIG. 3. The second access panels 56, 58 extend from the bottom end 24 of the enclosure 10 to the respective first and second vertically extending sidewalls 12, 14. Each of the first access panels 30, 32 and second access panels 56, 58 is in an angular orientation relative to the respective vertically extending sidewall 12, 14 and extends below top wall 26. In addition, each of the second access panels 56, 58 includes a third ventilation opening 60, 62, respectively. Furthermore, vertically extending sidewalls 12, 14 each include a respective fourth ventilation opening 64, 66 above respective ones of the angularly oriented third ventilation openings 60, 62.

The first and second access panels 30, 56 associated with first sidewall 12 are positioned in side-by-side relation, and the first and second access panels 32, 58 associated with the second sidewall 14 are in side-by-side relation. In one embodiment, the enclosure 10 includes a height H1 as shown in FIG. 4 between top and bottom ends 22, 24 and access panels 30, 32, 56, 58 extend along a height H2 of enclosure 10 that is around 20% of height H1. Other embodiments contemplate height H2 ranging from 10% to 30% of H1, or any other suitable height H2 that allows one or more ventilation openings to be provided directly vertically below top wall 26.

In the illustrated embodiment, first sidewall 12 includes first and second vertically extending sidewall parts 65, 67 in side-by-side position extending from respective ones of the two access panels 30, 56 to the top wall 26. The second ventilation opening 38 is provided in first sidewall part 65 and the fourth ventilation opening 64 is provided in second sidewall part 67.

In the illustrated embodiment, second sidewall 14 includes third and fourth vertically extending sidewall parts 68, 70 in side-by-side position extending from respective ones of the two access panels 32, 58 to the top wall 26. The second ventilation opening 40 is provided in third sidewall part 68 and the fourth ventilation opening 66 is provided in fourth sidewall part 70.

In the illustrated embodiment, first sidewall 12 also includes a first intermediate column 72 between the first and second vertically extending sidewall parts 65, 67. First sidewall 12 can further include a first intermediate strut 74 between the two access panels 30, 56. The first intermediate strut 74 extends from the intermediate column 72 to the base 28, and the first intermediate column 72 extends from the first intermediate strut 74 toward the top end 22 of the enclosure 10.

In the illustrated embodiment, first sidewall 12 also includes a second intermediate column 76 between the first intermediate column 72 and the third sidewall 16. A third intermediate column 78 is between the first intermediate column 72 and the opposite fourth sidewall 18. In addition, a second intermediate strut 80 is between the first intermediate strut 74 and the first corner strut 52 at third sidewall 16, the second intermediate strut 80 extending from the second intermediate column 76 to the base 28. The second intermediate column 76 extends from the second intermediate strut 80 toward the top end 22 of the enclosure 10. A third intermediate strut 82 is located between the first intermediate strut 74 and the third corner strut (opposite corner strut 52) at fourth sidewall 18. The third intermediate strut 82 extends from the third intermediate column 78 to the base 28 of the enclosure 10. The third intermediate column 78 extends from the third intermediate strut 82 toward the top end 22 of the enclosure 10.

In the illustrated embodiment, second sidewall 14 may also include a fourth intermediate column 84 between the third and fourth vertically extending sidewall parts 68, 70. There can further be provided a fourth intermediate strut 86 between the two access panels 32, 58. The fourth intermediate strut 86 extends from the fourth intermediate column 84 to the base 28, and the fourth intermediate column 84 extends from the fourth intermediate strut 86 toward the top end 22 of the enclosure 10.

In the illustrated embodiment, second sidewall 14 also includes a fifth intermediate column 88 between the fourth intermediate column 84 and the third sidewall 16. A sixth intermediate column 90 is between the fourth intermediate column 84 and fourth sidewall 18. In addition, a fifth intermediate strut 92 is between the fourth intermediate strut 86 and the second corner strut 54 at third sidewall 16, and the fifth intermediate strut 92 extends from the fifth intermediate column 88 to the base 28. The fourth intermediate column 84 extends from the fourth intermediate strut 86 toward the top end 22 of the enclosure 10. A sixth intermediate strut 94 is between the fourth intermediate strut 86 and the fourth corner strut (opposite corner strut 54) at fourth sidewall 18. The sixth intermediate strut 94 extends from the sixth intermediate column 90 to the base 28 of the enclosure 10. The sixth intermediate column 90 extends from the sixth intermediate strut 94 toward the top end 22 of the enclosure 10.

Other embodiments contemplate other arrangements for the struts and columns that differ from those described herein. In still other embodiments, all or a portion of the struts and columns can be omitted, or additional struts and/or columns can be provided. Furthermore, although not specifically shown, top end 22 can include one or more beams to support top wall 26.

The angularly oriented struts 52, 74, 80, 82, 54, 86, 92, 94 and access panels 30, 56, 32, 58 disclosed herein can extend at an angle A toward the inner space 20 from an extension of the respective adjacent vertically extending sidewall, as shown in FIG. 4 with respect to first sidewall 12. Angle A can be any suitable angle to facilitate air up-flow into and through the ventilation opening(s) of the respective access panel(s). In one embodiment, angle A is about 45 degrees. In other embodiments, angle A can be selected to be angle in the range from 30 degrees to 60 degrees.

In one embodiment, the enclosure 10 includes a first width W1 between first and second sidewalls 12, 14 at top end 22 and a second, smaller width W2 at bottom end 24 between the bottom ends of the access panels 30, 32, 54, 56. The access panels 30, 32 and 54, 56 are angled to connect the first width W1 to the second width W2. In this arrangement, the access panels 30, 32 extend inwardly from the respective sidewall 12, 14 and below top wall 26. In the illustrated embodiment, access panels 30, 32 each extend across a width W3 that is about 20% of the overall width W1. Other embodiments contemplate any other suitable width W3.

Various aspects of the present disclosure are contemplated. In one aspect, a transformer includes an enclosure with a plurality of vertically extending sidewalls forming an inner space, and the enclosure extends between a top end and a bottom end. At least one top wall connects the plurality of vertically extending sidewalls at or adjacent the top end of the enclosure, and a base is provided at the bottom end of the enclosure. At least one access panel is provided in an angular orientation relative to adjacent ones of the plurality of vertically extending sidewalls to extend below the at least one top wall. The at least one access panel extends in the angular orientation from the bottom end to a first one of the vertically extending sidewalls. The at least one access panel includes at least one first ventilation opening and at least one second ventilation opening is provided through the enclosure above the at least one first ventilation opening. The plurality of vertically extending sidewalls extend from the top wall to either the at least one access panel or the bottom end of the enclosure.

In one embodiment, the transformer includes a second access panel angled below the at least one top wall. The second access panel extends from the bottom end of the enclosure to a second one of the vertically extending sidewalls that is opposite the first one of the vertically extending sidewalls. The second access panel is in an angular orientation relative to the second one of the vertically extending sidewalls. In a refinement of this embodiment, the second access panel includes a third ventilation opening and the enclosure includes a fourth ventilation opening in the second one of the plurality of vertically extending sidewalls that is above the third ventilation opening.

In yet another embodiment, the at least one access panel includes two access panels in side-by-side position, and the at least one first ventilation opening is provided in one of the two access panels and a third ventilation opening is provided in the other of the two access panels. In a refinement of this embodiment, the first one of the vertically extending sidewalls includes first and second vertically extending sidewall parts in side-by-side position extending from respective ones of the two access panels to the top wall, and the at least one second ventilation opening is provided in one of the first and second vertically extending sidewall parts and a fourth ventilation opening is provided in the other of the first and second vertically extending sidewall parts. In a further refinement, the enclosure includes a first intermediate column between the first and second vertically extending sidewall parts and a first intermediate strut between the two access panels. The first intermediate strut extends from the intermediate column to the base, and the first intermediate column extends from the first intermediate strut toward the top end of the enclosure.

In yet a further refinement of the above embodiments, the enclosure includes a first corner column and a second corner column at opposite sides of the first one of the vertically extending sidewalls, and a first corner strut and a second corner strut extending from respective one of the first and second corner columns to the base of the enclosure. The first and second corner struts parallel the two access panels, and the first and second corner columns extend from respective ones of the first and second corner struts toward the top wall of the enclosure. In still a further refinement, the enclosure includes a second intermediate column between the first intermediate column and the first corner column, a third intermediate column between the first intermediate column and the second corner column, a second intermediate strut between the first intermediate strut and the first corner strut, and a third intermediate strut between the first intermediate strut and the second corner strut. The second intermediate strut extends from the second intermediate column to the base, and the second intermediate column extends from the second intermediate strut toward the top end of the enclosure. The third intermediate strut extends from the third intermediate column to the base of the enclosure, and the third intermediate column extends from the third intermediate strut toward the top end of the enclosure.

In one embodiment, the plurality of vertically extending sidewalls includes a second one of the vertically extending sidewalls that is opposite the first one of the vertically extending sidewalls. The plurality of vertically extending sidewalls further include opposite third and fourth ones of the vertically extending sidewalls that extend transversely to and connect the first and second ones of the vertically extending sidewalls. The enclosure includes at least one second access panel below the at least one top wall that extends from the base of the enclosure to the second one of the vertically extending sidewalls in an angular orientation relative to the second one of the vertically extending sidewalls. The at least one second access panel includes at least one third ventilation opening and at least one fourth ventilation opening is provided through the second one of the vertically extending sidewalls above the at least one third ventilation opening. In a refinement of this embodiment, the third and fourth ones of the vertically extending sidewalls each include at least one wall panel extending from the top wall to the bottom end of the enclosure and from the first one of the vertically extending sidewalls and first access panel to the second one of the vertically extending sidewalls and second access panel.

In one embodiment, the first one of the vertically extending sidewalls defines a first plane and the at least one access panel forms an angle from the first plane toward the inner space. T the angle ranges from 30 degrees to 60 degrees. In a refinement of this embodiment, the angle is 45 degrees. In another embodiment, the plurality of vertically extending sidewalls forms a rectangular shape.

In another embodiment, the transformer includes a core and a coil assembly mounted to the core in the inner space of the enclosure. In yet another embodiment, the at least one access panel extends along about 20% of an overall height of the enclosure and across about 20% of an overall width of the enclosure.

Another aspect is directed to an enclosure for a transformer. The enclosure includes a plurality of vertically extending sidewalls forming an inner space for receiving a transformer coil assembly. At least one top wall connects the plurality of vertically extending sidewalls above the inner space. At least one access panel is in an angular orientation relative to a first one of the vertically extending sidewalls to extend from the first one of the vertically extending sidewalls below the at least one top wall. The at least one access panel includes at least one first ventilation opening and at least one second ventilation opening is provided in the first one of the vertically extending sidewalls above the at least one first ventilation opening. The at least one access panel extends from the first one of the vertically extending sidewalls to a bottom end of the enclosure.

In one embodiment, a base is opposite the at least one top wall and the at least one access panel extends from the first one of the vertically extending sidewalls toward the base.

In another embodiment, the enclosure includes a second access panel below the at least one top wall. The second access panel extends from the base to a second one of the vertically extending sidewalls that is opposite the first one of the vertically extending sidewalls. The second access panel is in an angular orientation relative to the second one of the vertically extending sidewalls. In a refinement of this embodiment, the second access panel includes a third ventilation opening and the enclosure includes a fourth ventilation opening in the second one of the vertically extending sidewalls that is above the third ventilation opening.

In another embodiment, the first one of the vertically extending sidewalls defines a first plane and the at least one access panel forms an angle from the first plane toward the inner space, wherein the angle ranges from 30 degrees to 60 degrees. In a refinement of this embodiment, the angle is 45 degrees.

While the invention has been illustrated and described in detail in the drawings and foregoing description, the same is to be considered as illustrative and not restrictive in character, it being understood that only the certain embodiments have been shown and described and that all changes and modifications that come within the spirit of the inventions are desired to be protected. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary. Unless specified or limited otherwise, the terms “engaged,” “connected,” “supported,” and “coupled” and variations thereof are used broadly and encompass both direct and indirect engagements, connections, supports, and couplings.

What is claimed is:

1. A transformer, comprising:
an enclosure including a plurality of vertically extending sidewalls forming an inner space, the enclosure extending between a top end and a bottom end;
at least one top wall connecting the plurality of vertically extending sidewalls at or adjacent the top end of the enclosure;
a base at the bottom end of the enclosure;
at least one access panel in an angular orientation relative to adjacent ones of the plurality of vertically extending sidewalls to extend below the at least one top wall, the at least one access panel extending in the angular orientation from the bottom end to a first one of the vertically extending sidewalls, wherein the at least one access panel includes at least one first ventilation opening;
at least one second ventilation opening through the enclosure above the at least one first ventilation opening; and
the plurality of vertically extending sidewalls extend from the top wall to either the at least one access panel or the bottom end of the enclosure.

2. The transformer of claim 1, further comprising a second access panel angled below the at least one top wall, the second access panel extending from the bottom end of the enclosure to a second one of the vertically extending sidewalls that is opposite the first one of the vertically extending sidewalls, wherein the second access panel is in an angular orientation relative to the second one of the vertically extending sidewalls.

3. The transformer of claim 2, wherein the second access panel includes a third ventilation opening and further comprising a fourth ventilation opening in the second one of the plurality of vertically extending sidewalls, the fourth ventilation opening being above the third ventilation opening.

4. The transformer of claim 1, wherein the plurality of vertically extending sidewalls forms a rectangular shape.

5. The transformer of claim 1, wherein the at least one access panel includes two access panels in side-by-side position, and the at least one first ventilation opening is provided in one of the two access panels and a third ventilation opening is provided in the other of the two access panels.

6. The transformer of claim 5, wherein the first one of the vertically extending sidewalls includes first and second vertically extending sidewall parts in side-by-side position extending from respective ones of the two access panels to the top wall, and the at least one second ventilation opening is provided in one of the first and second vertically extending sidewall parts and a fourth ventilation opening is provided in the other of the first and second vertically extending sidewall parts.

7. The transformer of claim 6, further comprising a first intermediate column between the first and second vertically extending sidewall parts and a first intermediate strut between the two access panels, the first intermediate strut extending from the intermediate column to the base, wherein the first intermediate column extends from the first intermediate strut toward the top end of the enclosure.

8. The transformer of claim 7, further comprising:
a first corner column and a second corner column at opposite sides of the first one of the vertically extending sidewalls; and
a first corner strut and a second corner strut extending from respective one of the first and second corner columns to the base of the enclosure, wherein the first and second corner struts parallel the two access panels, and the first and second corner columns extend from respective ones of the first and second corner struts toward the top wall of the enclosure.

9. The transformer of claim 8, further comprising:
a second intermediate column between the first intermediate column and the first corner column;
a third intermediate column between the first intermediate column and the second corner column;
a second intermediate strut between the first intermediate strut and the first corner strut, the second intermediate strut extending from the second intermediate column to the base, wherein the second intermediate column extends from the second intermediate strut toward the top end of the enclosure; and
a third intermediate strut between the first intermediate strut and the second corner strut, the third intermediate strut extending from the third intermediate column to the base of the enclosure, wherein the third intermediate column extends from the third intermediate strut toward the top end of the enclosure.

10. The transformer of claim 1, wherein the plurality of vertically extending sidewalls includes a second one of the vertically extending sidewalls that is opposite the first one of the vertically extending sidewalls, the plurality of vertically extending sidewalls further includes opposite third and fourth ones of the vertically extending sidewalls that extend transversely to and connect the first and second ones of the vertically extending sidewalls, and further comprising:
at least one second access panel below the at least one top wall that extends from the base of the enclosure to the second one of the vertically extending sidewalls in an angular orientation relative to the second one of the vertically extending sidewalls, wherein the at least one second access panel includes at least one third ventilation opening; and
at least one fourth ventilation opening through the second one of the vertically extending sidewalls above the at least one third ventilation opening.

11. The transformer of claim 10, wherein the third and fourth ones of the vertically extending sidewalls each include at least one wall panel extending from the top wall to the bottom end of the enclosure and from the first one of the vertically extending sidewalls and first access panel to the second one of the vertically extending sidewalls and second access panel.

12. The transformer of claim 1, wherein the first one of the vertically extending sidewalls defines a first plane and the at least one access panel forms an angle from the first plane toward the inner space, wherein the angle ranges from 30 degrees to 60 degrees.

13. The transformer of claim 12, wherein the angle is 45 degrees.

14. The transformer of claim 1, further comprising a core and a coil assembly mounted to the core in the inner space of the enclosure.

15. The transformer of claim 1, wherein the at least one access panel extends along about 20% of an overall height of the enclosure and across about 20% of an overall width of the enclosure.

16. An enclosure for a transformer, comprising:
a plurality of vertically extending sidewalls forming an inner space for receiving a transformer coil assembly;
at least one top wall connecting the plurality of vertically extending sidewalls above the inner space;
at least one access panel in an angular orientation relative to a first one of the vertically extending sidewalls, the at least one access panel angled to extend from the first one of the vertically extending sidewalls below the at least one top wall, wherein the at least one access panel includes at least one first ventilation opening;
at least one second ventilation opening in the first one of the vertically extending sidewalls above the at least one first ventilation opening; and
a bottom end opposite the at least one top wall, wherein the at least one access panel extends from the first one of the vertically extending sidewalls toward the bottom end of the enclosure.

17. The enclosure of claim 16, further comprising a second access panel below the at least one top wall, the second access panel extending from the base to a second one of the vertically extending sidewalls that is opposite the first one of the vertically extending sidewalls, wherein the second access panel is in an angular orientation relative to the second one of the vertically extending sidewalls.

18. The enclosure of claim 17, wherein the second access panel includes a third ventilation opening and further comprising a fourth ventilation opening in the second one of the vertically extending sidewalls that is above the third ventilation opening.

19. The transformer of claim 16, wherein the first one of the vertically extending sidewalls defines a first plane and the at least one access panel forms an angle from the first plane toward the inner space, wherein the angle ranges from 30 degrees to 60 degrees.

20. The transformer of claim 19, wherein the angle is 45 degrees.
